(19) United States
(12) Patent Application Publication
(10) Pub. No.: US 2023/0036444 A1
(43) Pub. Date: Feb. 2, 2023

(54) SYSTEM, METHOD, AND NON-TRANSITORY STORAGE MEDIUM

(71) Applicant: TOYOTA JIDOSHA KABUSHIKI KAISHA, Toyota-shi (JP)

(72) Inventors: Tomoyasu ISHIKAWA, Nagoya-shi (JP); Shunsuke TANIMORI, Toyota-shi (JP)

(73) Assignee: TOYOTA JIDOSHA KABUSHIKI KAISHA, Toyota-shi (JP)

(21) Appl. No.: 17/839,948

(22) Filed: Jun. 14, 2022

(30) Foreign Application Priority Data
Jul. 28, 2021 (JP) 2021-123503

(51) Int. Cl. G06F 8/65; B60W 50/14

(52) U.S. Cl. CPC G06F 8/65; B60W 50/14; B60W 2050/146

(57) ABSTRACT

A system is configured to control a software update for an electronic control unit mounted on a vehicle. The system includes: a first center including one or more first processors configured to execute processing for the software update on the vehicle; the vehicle configured to execute the software update for the electronic control unit based on the processing by the first center; and a second center including one or more second processors configured to provide information on the software update to a user of the vehicle, and transmit, to the first center, a notification indicating that the information on the software update is provided to the user of the vehicle. The one or more first processors of the first center is configured to, after receiving the notification from the second center, execute the processing on the vehicle based on the notification.

### CROSS-REFERENCE TO RELATED APPLICATION

This application claims priority to Japanese Patent Application No. 2021-123503 filed on Jul. 28, 2021, incorporated herein by reference in its entirety.

### BACKGROUND

### 1. Technical Field

The present disclosure relates to a system, a method, and a non-transitory storage medium.

### 2. Description of Related Art

A plurality of electronic control units (ECUs) used for controlling an operation of a vehicle is mounted on the vehicle. The ECU includes a processor, a transitory storage unit, such as a random access memory (RAM), and a non-volatile memory which is a non-volatile storage unit, such as a flash read-only memory (ROM). A control function of the ECU is implemented when the processor executes software stored in the non-volatile memory. Software stored in each ECU is rewritable, and by updating to a newer version of the software, it is possible to improve a function of each ECU or add a new vehicle control function.

As a technology for updating software of an ECU, an over-the-air (OTA) technology is known. In the OTA technology, a device that wirelessly connects an in-vehicle communication device connected to an in-vehicle network to a communication network, such as the Internet, and executes software update processing of the vehicle updates or adds the software of the ECU by executing download of software from a server via wireless communication, installation for writing the downloaded software on the ECU, and activation for making the installed software active (see, for example, Japanese Unexamined Patent Application Publication No. 2017-149323.)

### SUMMARY

When a software update using an OTA is executed, processing, such as sending a notification indicating that there is a software update or requesting an approval of the software update from a user, a manager, or the like of a vehicle, is executed. This notification, approval request, or the like is generally sent to the user, the manager, or the like of the vehicle via a car navigation device mounted on the vehicle.

However, when the vehicle does not have a high-functioning display device, such as a car navigation device, mounted thereon, the user, the manager, or the like who does not separately own a device (for example, an information terminal, such as a smartphone or a personal computer, which can wirelessly communicate with the vehicle) that replaces the display device, such as the car navigation device, cannot receive information on an update when the software update using the OTA is required.

The present disclosure provides a vehicle system, a method, and a non-transitory storage medium in which a user, a manager, or the like of a vehicle can receive information on a software update when the software update using an OTA is executed.

A system according to a first aspect of the present disclosure is configured to control a software update for an electronic control unit mounted on a vehicle. The system includes: a first center including one or more first processors configured to execute processing for the software update on the vehicle; the vehicle configured to execute the software update for the electronic control unit based on the processing by the first center; and a second center including one or more second processors configured to provide information on the software update to a user of the vehicle, and transmit, to the first center, a notification indicating that the information on the software update is provided to the user of the vehicle. The one or more first processors of the first center is configured to, after receiving the notification from the second center, execute the processing on the vehicle based on the notification.

A method according to a second aspect of the present disclosure is executed by a first center. The first center includes one or more processors and a memory. The first center composes a system controlling a software update for an electronic control unit mounted on a vehicle. The first center is configured to execute processing for the software update on the vehicle. The method includes: receiving a notification indicating that information on the software update is provided to a user of the vehicle from a second center configured to provide the information on the software update to the user of the vehicle; and executing, after receiving the notification from the second center, the processing on the vehicle based on the notification.

A non-transitory storage medium according to a third aspect of the present disclosure stores instructions that are executable by a computer of a first center and that cause the computer to execute functions. The first center includes one or more processors and a memory. The first center composing a system controlling a software update for an electronic control unit mounted on a vehicle. The first center being configured to execute processing for the software update on the vehicle. The functions include: receiving a notification indicating that information on the software update is provided to a user of the vehicle from a second center configured to provide the information on the software update to the user of the vehicle; and executing, after receiving the notification from the second center, the processing on the vehicle based on the notification.

With each aspect of the present disclosure, a user, a manager, or the like of a vehicle can receive information on a software update when the software update using an OTA is executed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of a network system according to an embodiment;

FIG. 2 is a block diagram illustrating an overall configuration of a first center;

FIG. 3 is a functional block diagram of the first center;

FIG. 4 is a block diagram illustrating an overall configuration of an OTA master;

FIG. 5 is a functional block diagram of the OTA master;

FIG. 6 is a flowchart of processing for transmitting information on a software update executed by the first center and a second center;

FIG. 7 is one example of management information stored in the second center; and

FIG. 8 is a flowchart describing one example of software update control processing executed by the first center, the OTA master, and a target electronic control unit.

### DETAILED DESCRIPTION OF EMBODIMENTS

In a system according to the present disclosure, when a software update for an electronic control unit (ECU) mounted on a vehicle is executed, in a case where a display device mounted on the vehicle cannot sufficiently display information on the software update, a customer center and the like provides the information on the software update to a user, a manager, or the like of the vehicle using a telephone or a postcard. As such, the user, the manager, or the like of the vehicle can receive required information on the software update using an OTA even when he or she does not own a high-functioning device, such as a car navigation device. Hereinafter, one embodiment of the present disclosure will be described in detail with reference to drawings.

### EMBODIMENTS

### System Configuration

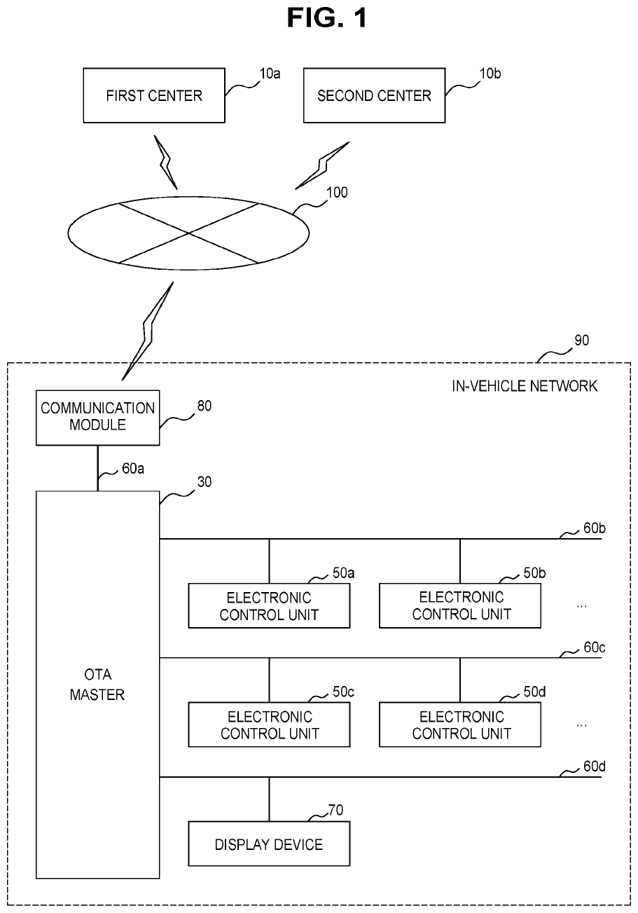

FIG. 1 is a block diagram illustrating an overall configuration of a network system according to one embodiment of the present disclosure. The network system illustrated in FIG. 1 is used for updating software of a plurality of ECUs 50a to 50d mounted on the vehicle, and includes a first center 10a and a second center 10b outside the vehicle, and an in-vehicle network 90 constructed inside the vehicle.

### (1) First Center

The first center 10a can communicate with an OTA master 30 (described below) included in the in-vehicle network 90 via a network 100, and can control and manage updates of the software of the ECUs 50a to 50d connected to the OTA master 30 by, for example, transmitting a notification indicating that there is a software update, a description of the software update, or the like to the user, the manager, or the like of the vehicle, transmitting the update data of the software of the ECUs 50a to 50d and information defining update processing procedures, or receiving a notification indicating a proceeding situation of the software update processing. The first center 10a functions as a so-called server. Further, the first center 10a can communicate with the second center 10b via the network 100 and receive a required notification from the second center 10b.

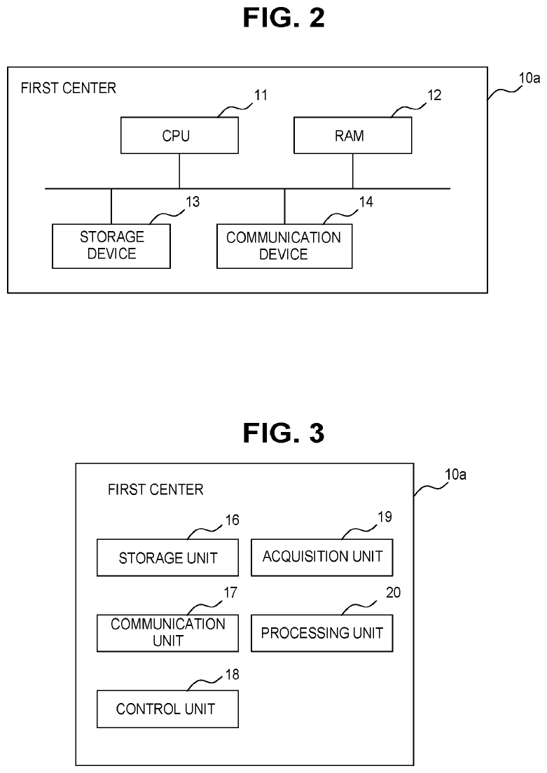

FIG. 2 is a block diagram illustrating a schematic configuration of the first center 10a in FIG. 1. As illustrated in FIG. 2, the first center 10a includes a central processing unit (CPU) 11, a random access memory (RAM) 12, a storage device 13, and a communication device 14. Each of the numbers of the CPUs 11, RAMs 12, the storage devices 13, and the communication devices 14 is not limited to one, and may be plural. The storage device 13 includes a readable and writable storage medium, such as a hard disk drive (HDD) or a solid state drive (SSD), and stores a program used for executing software update management, information used for software update control and software update management, the update data of software of each ECU, and the like. In the first center 10a, the CPU 11 executes predetermined processing for the software update by executing a program read from the storage device 13 using the RAM 12 as a work area. The communication device 14 is used for communicating with the OTA master 30 or the second center 10b via the network 100.

FIG. 3 is a functional block diagram of the first center 10a illustrated in FIG. 2. The first center 10a illustrated in FIG. 3 includes a storage unit 16, a communication unit 17, a control unit 18, an acquisition unit 19, and a processing unit 20. A function of the storage unit 16 is implemented by the storage device 13 illustrated in FIG. 2. Functions of the communication unit 17, the control unit 18, the acquisition unit 19, and the processing unit 20 are implemented when the CPU 11 illustrated in FIG. 2 executes a program stored in the storage device 13 using the RAM 12.

The storage unit 16 stores information on the software update processing of one or more ECUs mounted on the vehicle. As the information on the software update processing, the storage unit 16 at least stores update management information in which information indicating software that can be used in the ECUs 50a to 50d is associated with each piece of vehicle identification information (a vehicle ID) for identifying a vehicle, and the update data of the software of the ECUs 50a to 50d. As the information indicating the software that can be used in the ECUs 50a to 50d, for example, a combination of latest version information of each piece of software of the ECUs 50a to 50d is defined. As the information on the software update processing, the storage unit 16 can store an update status indicating a software update state executed in the vehicle. Further, as the information on the software update processing, the storage unit 16 can store information on an update sequence indicating software update processing procedures, which is used for giving a control instruction to the OTA master 30. Further, the storage unit 16 can store information on the display device 70 mounted on the vehicle, which has been acquired by the acquisition unit 19 described below.

The communication unit 17 functions as a transmission unit and receiving unit that transmits and receives data, information, notifications, requests, and the like, to and from the OTA master 30 (the vehicle) or to and from the second center 10b. The communication unit 17 receives an update confirmation request of the software from the OTA master 30 (the receiving unit). The update confirmation request may be, for example, information transmitted from the OTA master 30 to the first center 10a at a time when a power supply or an ignition is turned on (hereinafter, referred to as “power supply ON”) in the vehicle, and is information for requesting the first center 10a to confirm whether there is the update data for the ECUs 50a to 50d based on vehicle configuration information described below. Further, the communication unit 17 transmits information indicating whether there is the update data to the OTA master 30 in response to the update confirmation request received from the OTA master 30 (the transmission unit). Further, the communication unit 17 receives a transmission request (a download request) for the distribution package from the OTA master 30 (the receiving unit). Further, upon receiving the download request for the distribution package (the receiving unit), the communication unit 17 transmits, to the OTA master 30, the distribution package including the update data of the software of the ECUs 50a to 50d and the like generated by the control unit 18 described below (the transmission unit). Further, based on an instruction of the processing unit 20, the communication unit 17 transmits, to the vehicle, the notification that there is the software update, description of the software update, an approval request for the software update, or the like (collectively referred to as “information on the software update”) for the user, the manager, or the like of the vehicle (the transmission unit). Further, the communication unit 17 can receive, from the vehicle, a request for re-transmission of the information on the display device 70 mounted on the vehicle or the information on the software update (the receiving unit). Further, the communication unit 17 can receive, from the second center 10b, the notification indicating that information on the software update has been provided to the user, the manager, or the like of the vehicle (the receiving unit).

When the communication unit 17 receives the update confirmation request from the OTA master 30, the control unit 18 determines, based on the update management information stored in the storage unit 16, whether there is the update data of the software of the ECUs 50a to 50d mounted on the vehicle specified by the vehicle ID, which is included in the update confirmation request. The determination result, by the control unit 18, of whether there is the update data is transmitted by the communication unit 17 to the OTA master 30. When the control unit 18 determines that there is the update data of the software of the ECUs 50a to 50d and the communication unit 17 receives the download request for the distribution package from the OTA master 30, the control unit 18 generates one or more distribution packages including the update data and the like stored in the storage unit 16. Further, the control unit 18 controls software update processing of the ECUs 50a to 50d based on an update approval notification from the user, the manager, or the like of the vehicle that is received from the vehicle as a response to the information on the software update transmitted by the processing unit 20, or a notification indicating that the information on the software update has been provided to the user, the manager, or the like of the vehicle that is received from the second center 10b.

The acquisition unit 19 acquires the information on the display device 70 mounted on the vehicle from the vehicle via the communication unit 17. The information on the display device 70 at least includes information indicating whether the display device 70 can display, on its screen, information that should be described in advance (changes in control and the like) to the user, the manager, or the like of the vehicle when the software update using the OTA is executed. The information can be displayed on the screen, which typically means that the entire information that should be described in advance can be provided to the user, the manager, or the like of the vehicle via the screen. The information on the display device 70 may be acquired by, for example, the first center 10a from the vehicle every time the power supply is ON in the vehicle, or acquired in advance by other methods.

When the software update using the OTA is executed, the processing unit 20 executes processing for transmitting the information on the software update based on the information on the display device 70 mounted on the vehicle. More specifically, when the software update using OTA is executed, in a case where the display device 70 can display, on its screen, the information that should be described in advance to the user, the manager, or the like of the vehicle, the processing unit 20 executes processing for transmitting the information on the software update to the vehicle (the OTA master 30). On the other hand, when the software update using OTA is executed, in a case where the display device 70 cannot display, on its screen, the information that should be described in advance to the user, the manager, or the like of the vehicle, the processing unit 20 gives the second center 10b an instruction on providing the information on the software update to the user, the manager, or the like of the vehicle. As such, the processing unit 20 operates as a so-called human-machine interface (HMI) function unit. The OTA master 30 may acquire the notification from the first center 10a to the vehicle and control the display of the display device 70 based on the notification, or the display device 70 may directly receive the notification without going through the OTA master 30 and execute a display based on the notification by itself

### (2) Second Center

The second center 10b is a facility in which an operator or the like is stationed, such as a so-called customer center or a call center, and an artificial operation intervenes in a control. A part of a configuration of the second center 10b can be represented by a block diagram illustrated in FIG. 2, and a part of functions of the second center 10b can be represented by a block diagram as illustrated in FIG. 3. In the second center 10b, the vehicle in association with the user, the manager, or the like of the vehicle is managed, and an address, a telephone number, or the like is registered in advance in a server of the facility as a contact information of the user, a manager, or the like. In the second center 10b, an operator or the like provides the information on the software update to the user, the manager, or the like of the vehicle of which the software is to be updated using the OTA, via a telephone or a postcard. Further, when the information on the software update has been provided to the user, the manager, or the like of the vehicle, a notification indicating the fact that the above information has been provided to the user, the manager, or the like of the vehicle is transmitted to the first center 10a. This transmission may be autonomously executed by a communication device and the like, or may be manually executed by an operator or the like. Further, the second center 10b receives an approval of the provided information on the software update from the user, the manager, or the like of the vehicle. These processes will be described below.

### (3) In-Vehicle Network

The in-vehicle network 90 includes the OTA master 30, the ECUs 50a to 50d, a display device 70, and a communication module 80. The OTA master 30 is connected to the communication module 80 via a bus 60a, connected to the ECUs 50a, 50b via a bus 60b, and connected to the ECUs 50c, 50d via a bus 60c. The OTA master 30 is connected to the display device 70 via a bus 60d.

The OTA master 30 can communicate with the first center 10a via the bus 60a and the communication module 80 by way of the network 100 in a wireless manner. Further, the OTA master 30 can communicate with the ECUs 50a to 50d and the display device 70 via the buses 60b to 60d in a wired manner. The OTA master 30 has functions of managing an OTA state and executing the software update for an ECU to be updated (hereinafter, also referred to as a “target ECU”) by controlling the update sequence, which is a flow of the software update processing. The OTA master 30 controls the software update for the target ECU from among the ECUs 50a to 50d based on the update data and the like that are acquired from the first center 10a. Further, the OTA master 30 can appropriately control the screen display of the display device 70 based on the information on the software update or the notification received from the first center 10a. The OTA master 30 may also be referred to as a central gateway (CGW).

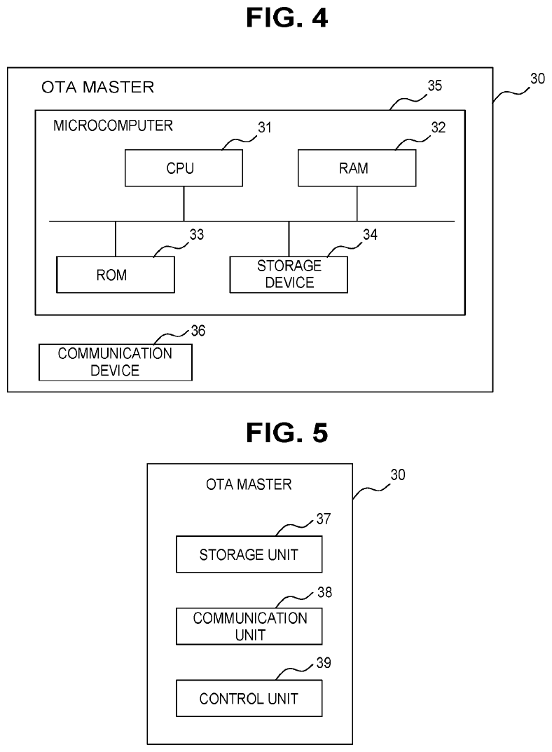

FIG. 4 is a block diagram illustrating a schematic configuration of the OTA master 30 in FIG. 1. As illustrated in FIG. 4, the OTA master 30 includes a CPU 31, a RAM 32, a read-only memory (ROM) 33, a storage device 34, and a communication device 36. The CPU 31, the RAM 32, the ROM 33, and the storage device 34 compose a microcomputer 35. The number of microcomputers 35 is not limited to one and may be plural. In the OTA master 30, the CPU 31 executes predetermined processing for the software update by executing a program read from the ROM 33 using the RAM 32 as a work area. The number of CPUs 31 is not limited to one. The communication device 36 is used for communicating with each of the communication module 80, the ECUs 50a to 50d, and the display device 70 via the buses 60a to 60d illustrated in FIG. 1.

FIG. 5 is a functional block diagram of the OTA master 30 illustrated in FIG. 4. The OTA master 30 illustrated in FIG. 5 includes a storage unit 37, a communication unit 38, and a control unit 39. A function of the storage unit 37 is implemented by the storage device 34 illustrated in FIG. 4. Functions of the communication unit 38 and the control unit 39 are implemented when the CPU 31 illustrated in FIG. 4 executes a program stored in the ROM 33 using the RAM 32.

In addition to a program (a control program of the OTA master 30) for updating the software of the ECUs 50a to 50d or various pieces of data used when updating the software, the storage unit 37 stores the software update data and the like that are downloaded from the first center 10a. Further, the storage unit 37 can store the information on the types of the non-volatile memories mounted on the ECUs 50a to 50d, respectively. Further, the storage unit 37 can store the information on the display device 70.

The communication unit 38 functions as a transmission unit and receiving unit that transmits and receives data, information, notifications, requests, and the like to and from the first center 10a. The communication unit 38 transmits the update confirmation request of the software to the first center 10a at, for example, the time of power supply ON in the vehicle (the transmission unit). The update confirmation request includes, for example, a vehicle ID for identifying the vehicle and the information on the current versions of the software of the ECUs 50a to 50d connected to the in-vehicle network 90. The vehicle ID and the current versions of the software of the ECUs 50a to 50d are used for determining whether there is the update data of the software of the ECUs 50a to 50d by comparing them with the latest software version held by the first center 10a for each vehicle ID. Further, as a response to the update confirmation request, the communication unit 38 receives, from the first center 10a, a notification indicating whether there is the update data (the receiving unit). When there is the update data of the software of the ECUs 50a to 50d, the communication unit 38 transmits, to the first center 10a, the download request for the distribution package including the software update data and the like (the transmission unit), and receives (downloads) the distribution package transmitted from the first center 10a (the receiving unit). Further, the communication unit 38 transmits, to the first center 10a, the software update state transmitted by the ECUs 50a to 50d (the transmission unit). Further, the communication unit 38 can cause, based on the instruction of the control unit 39, the display device 70 to display the information on the software update, the notification on the transmission of the information, or the state of the software update. Further, the communication unit 38 can transmit the information on the display device 70 to the first center 10a (the transmission unit).

The control unit 39 determines whether there is the update data of the software of the ECUs 50a to 50d based on the response, received by the communication unit 38 from the first center 10a, to the update confirmation request. Further, the control unit 39 verifies authenticity of the update data received (downloaded) in the distribution package by the communication unit 38 from the first center 10a and stored in the storage unit 37. Further, the control unit 39 controls the software update processing (the installation, the activation, and the like) of the ECUs 50a to 50d, using the update data downloaded from the first center 10a. Specifically, the control unit 39 transfers the downloaded update data to the target ECU and causes the target ECU to install update software based on the update data. After the completion of the installation, the control unit 39 gives the target ECU an instruction on the activation for making the installed update software active.

The ECUs 50a to 50d are devices used for controlling the operation of each part of the vehicle. FIG. 1 illustrates an example where the in-vehicle network 90 includes four ECUs 50a to 50d, but the number of ECUs is not particularly limited. Further, the number of buses connecting the ECUs 50a to 50d to the OTA master 30 is not particularly limited, either.

The display device 70 is a human-machine interface (HMI) used for, at the time of executing the software update processing of the ECUs 50a to 50d, executing various displays, such as a display representing that there is the update data, a display of the description of the software update and the like, an approval request screen for requesting approval of the software update from a user or a manager of the vehicle, and a display of a result or a state of the software update. As the display device 70, a display device of a car navigation system can be typically used, but the display device 70 is not particularly limited as long as it can display information required at the time of executing the software update processing. For example, the display device 70 also includes a simple HMI device, such as a meter, which cannot provide the information on the software update. In the present embodiment, a case where the information or the notification transmitted from the first center 10a is received by the display device 70 by way of the OTA master 30 is described. However, the display device 70 may receive the information or the notification directly from the communication module 80 without going through the OTA master 30 or directly via another communication device (not shown) other than the communication module 80. In addition to the display device 70, an ECU and the like may be further connected to the bus 60d illustrated in FIG. 1.

The communication module 80 is a unit having a function of controlling communication between the first center 10a and the vehicle, and is a communication device used for connecting the in-vehicle network 90 to the first center 10a. The communication module 80 is wirelessly connected to the center 10 by way of the network 100 such that the OTA master 30 executes vehicle authentication, downloading of the update data, or the like. The communication module 80 may be included in the OTA master 30.

The vehicle including the in-vehicle network 90 may be provided with an input unit, such as a switch (not shown) used for an approval of the software update processing from the user, the manager, or the like of the vehicle. This approval switch can be provided in, for example, the vicinity of the display device 70, or on a steering wheel.

### Overview of Software Update Processing

At, for example, the time of the power supply ON in the vehicle, the OTA master 30 transmits the update confirmation request of the software to the first center 10a. The update confirmation request includes a vehicle ID for identifying the vehicle and vehicle configuration information, which is information on a state of an ECU (a system configuration), such as current versions of hardware and the software of the ECUs 50a to 50d connected to the in-vehicle network 90. The vehicle configuration information can be generated by acquiring identification numbers (ECU_ID) of the ECUs and identification numbers of the software versions (ECU_Software_ID) of the ECUs from the ECUs 50a to 50d connected to the in-vehicle network 90. The vehicle ID and the current versions of the software of the ECUs 50a to 50d are used for determining whether there is the update data of the software of the ECUs 50a to 50d by comparing them with the latest software version held by the first center 10a for each vehicle ID. As a response to the update confirmation request received from the OTA master 30, the first center 10a transmits a notification indicating whether there is the update data, the information on the software update, or the like to the OTA master 30. When there is the update data of the software of the ECUs 50a to 50d, the OTA master 30 transmits, to the first center 10a, the download request for the distribution package. The first center 10a transmits, to the OTA master 30, the distribution package including the update data and the like according to the download request received from the OTA center 30. In addition to the update data, the distribution package may include verification data for verifying the authenticity of the update data, the number of pieces of the update data, type information, various pieces of control information used at the time of executing the software update, or the like.

The OTA master 30 determines whether there is the update data of the software of the ECUs 50a to 50d based on the response, received from the first center 10a, to the update confirmation request. Further, the OTA master 30 verifies the authenticity of the distribution package received from the first center 10a and stored in the storage device 13. Further, the OTA master 30 transfers the update data downloaded in the distribution package to the target ECU and causes the target ECU to install the update data. After the completion of the installation, the OTA master 30 gives the target ECU an instruction on the activation for making the installed updated version software active.

Further, in approval request processing, the first center 10a causes an output device to output the information for describing the software update, the notification indicating that the approval of the software update is required or a notification prompting an input indicating that the software update has been approved. As the output device, a display device 70 provided on the in-vehicle network 90 can be used. For example, in the approval request processing, when the display device 70 can display, on its screen, the information that should be described in advance to the user, the manager, or the like of the vehicle, the display device 70 is used as the output device. When the display device 70 is used as the output device, the OTA master 30 can cause the display device 70 to display the information on the software update, the approval request screen for requesting an approval of the software update from the user or the manager, a notification prompting a specific input operation, such as pressing of an approval button in the case where the user or the manager approves the request, or the like. In the approval request processing, when the display device 70 cannot display, on its screen, the information that should be described in advance to the user, the manager, or the like of the vehicle, the information provision is executed on the user, the manager, or the like of the vehicle by the second center 10b. In this case, the description on the content of the software update, the conformation of the approval of the software update, or the like is executed to the user or the manager. Upon determining that an approval has been obtained from the user or the manager via the OTA master 30, or via the notification from the second center 10b, the first center 10a gives the OTA master 30 an instruction on executing control processing of the above-described installation and activation to update the software of the target ECU.

Here, when the non-volatile memory of the target ECU is the single-bank memory having one storage area used for storing data, such as software, in principle, the approval request processing for the software update is executed before the execution of the installation because the installation and the activation are consecutively executed. Even for the target ECU of the single-bank memory, depending on information on an update sequence instructed from the first center 10a, it can be required that the update processing be temporarily stopped in a state where the installation is in a completed state, that is, the activation be suspended (on stand-by). Further, when the non-volatile memory of the target ECU is the dual-bank memory having two storage areas used for storing data, such as software, the approval request processing for the software update is executed at least after the execution of the installation and before the execution of the activation. When the non-volatile memory of the target ECU is the dual-bank memory, the approval request processing for the software update before the execution of the installation may be executed or omitted.

The software update processing is composed of a phase in which the OTA master 30 downloads the update data from the first center 10a (a download phase), a phase in which the OTA master 30 transfers the downloaded update data to the target ECU, and installs the update software on the storage area of the target ECU based on the update data (an installation phase), and a phase in which the target ECU makes the installed update software active (an activation phase).

The download is processing in which the OTA master 30 receives, from the first center 10a, the update data for updating the software of the ECU transmitted in the distribution package and stores it in the storage unit 37. Regarding reception of the update data by downloading, the download phase includes not only the execution of the download, but also controls of a series of processes on the download, such as determining whether the download can be executed and verifying the update data.

The update data transmitted from the first center 10a to the OTA master 30 may include any of the update software of the ECU (total data or difference data), the compressed data obtained by compressing the update software, and the divided data obtained by dividing the update software or the compressed data. Further, the update data may include the ECU_ID of the target ECU (or a serial number) and an ECU_Software_ID of the target ECU before the update. The update data is downloaded as the above-described distribution package, but the distribution package includes the update data for a single ECU or the plurality of ECUs.

The installation is processing in which the OTA master 30 writes the update software (the updated version program) on the non-volatile memories of target ECUs, based on the update data downloaded from the first center 10a. The installation includes not only the execution of the installation, but also controls of a series of processes on the installation, such as determining whether the installation can be executed, transferring the update data, and verifying the update software.

When the update data includes the update software itself (the total data), in the installation phase, the OTA master 30 transfers the update data (the update software) to the target ECU. Further, when the update data includes the compressed data of the update software, difference data of the update software, or divided data of the update software, the OTA master 30 may transfer the update data to the target ECU and the target ECU may generate the update software from the update data, or the OTA master 30 may generate the update software from the update data and then transfer the update software to the target ECU. Here, the update software can be generated by decompressing the compressed data or assembling (integrating) the difference data or the divided data.

The update software can be installed by the target ECU based on a request for the installation from the OTA master 30. A specific target ECU that has received the update data may autonomously execute the installation without receiving an explicit instruction from the OTA master 30.

The activation is processing in which the target ECU makes (activates) the update software installed on its non-volatile memory active. The activation phase includes not only the execution of the activation but also controls of a series of processes on the activation, such as determining whether the activation can be executed, requesting for the approval of the activation from the user or the manager of the vehicle, and verifying the execution result.

The update software can be activated by the target ECU based on a request for the activation from the OTA master 30. A specific target ECU that has received the update data may autonomously execute the activation after the completion of the installation without receiving an explicit instruction from the OTA master 30.

The software update processing can be executed continuously or in parallel to each of the target ECUs.

Further, the “software update processing” in the present specification includes not only processing for continuously executing all of the download, installation, and activation, but also processing for executing only a part of the download, installation, and activation.

### Processing

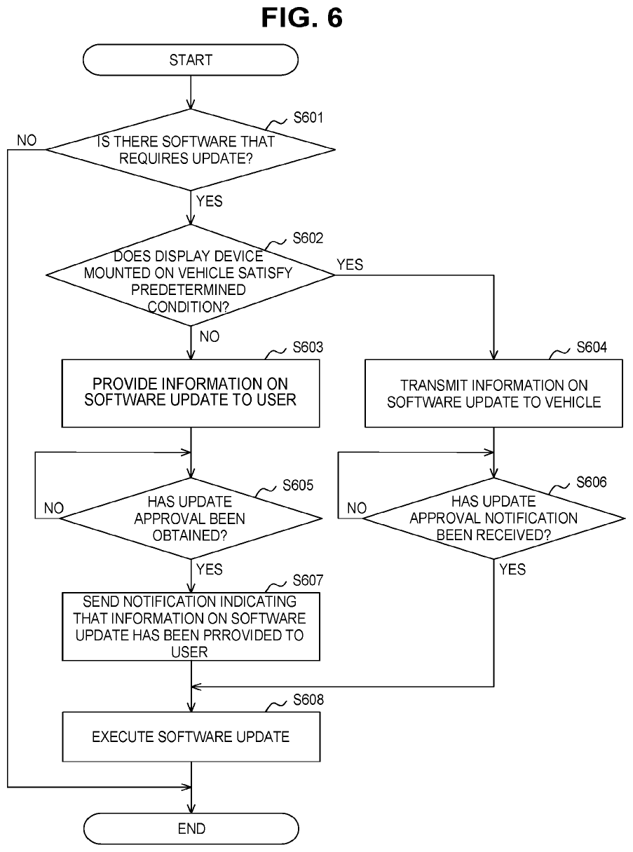

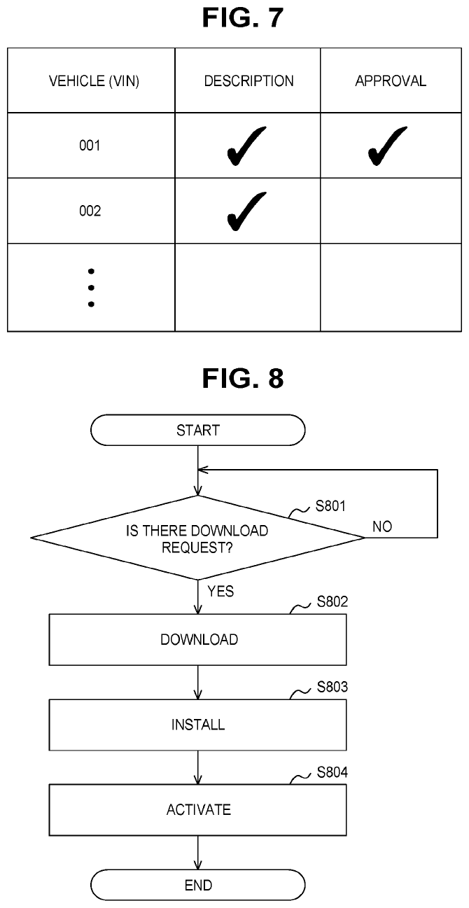

Next, the software update processing executed in the network system according to the present embodiment will be described with further reference to FIGS. 6 and 7.

FIG. 6 is a flowchart describing processing procedures for transmitting the information on the software update, executed by the first center 10a and the second center 10b. The first center 10a and the second center 10b frequently communicate with each other to share information required for determining processing.

(Step S601) The first center 10a determines whether there is software that requires an update in the vehicle. This determination can be made based on, for example, the current version of the piece of the software of each of the ECUs 50a to 50d mounted on the vehicle, which is included in the update confirmation request transmitted from the OTA master 30 and acquired from the vehicle confirmation information, and the latest version of each piece of software stored in the storage unit 16 or the first center 10a. When there is software that requires an update in the vehicle to be updated (step S601, YES), the process proceeds to step S602. On the other hand, when there is no software that requires an update in the vehicle to be updated (step S601, NO), the process ends.

(Step S602) The first center 10a determines whether the display device 70 mounted on the vehicle of which the software is to be updated satisfies a predetermined condition. Here, the predetermined condition is whether the display device 70 can display, on its screen, the information that should be described in advance (the content of a control change or the like) to the user, the manager, or the like of the vehicle when the software update using the OTA is executed. The determination as to whether this condition is satisfied is made based on the information on the display device 70 acquired by the acquisition unit 19. When the display device 70 of the vehicle of which the software is to be updated satisfies the predetermined condition (step S602, YES), the process proceeds to step S604. On the other hand, when the display device 70 of the vehicle of which the software is to be updated does not satisfy the predetermined condition (step S602, NO), the process proceeds to step S603.

(Step S603) The second center 10b provides the information on the software update (the description of the content of the software update, the approval request for the software update, or the like) to the user, the manager, or the like of the vehicle of which the software is to be updated. Examples of methods of the information provision can include (i) a method in which an operator of the second center 10b calls a contact information of the user, the manager, or the like to verbally describe the information on the software update, (ii) a method in which the second center 10b sends a postcard or a sealed letter to the contact information of the user, the manager, or the like to describe the information on the software update in text written on the postcard or the sealed letter, and (iii) a method in which the second center 10b sends a postcard or a sealed letter to the contact information of the user, the manager, or the like to describe the information on the software update by receiving a contact from the user, the manager, or the like to a call center stated in the postcard or the sealed letter. When the information on the software update is provided to the user, the manager, or the like of the vehicle, the process proceeds to step S605.

(Step S604) The first center 10a transmits the information on the software update (the description of the content of the software update, the approval request for the software update, or the like) to the vehicle (the OTA master 30) of which the software is to be updated. The display device 70 of the vehicle that has received this information displays, on its screen, the information based on the information on the software update. When the information on the software update is transmitted to the vehicle, the process proceeds to step S606.

(Step S605) The second center 10b determines whether the user, the manager, or the like of the vehicle has approved the software update. By this update approval, it can be determined that the user, the manager, or the like of the vehicle has understood the content of the software update and then agreed on the update. As a method of obtaining an update approval, for example, in the case of the method of the information provision (i) or (iii) described in step S603, the approval can be obtained by the operator directly from the user, the manager, or the like by telephone. Further, in the case of the method of the information provision (ii) described in step S603, the approval can be obtained by receiving a reply postcard indicating approval. Alternatively, for example, the update approval can be obtained by pressing the approval switch provided in advance inside the vehicle.

A case where the description of the content of the software update to the user, the manager, or the like of the vehicle and the approval of the software update from the user, the manager, or the like are not simultaneously executed is also considered. Therefore, the second center 10b may store management information indicating how far the execution has been completed for each user, manager, or the like. FIG. 7 illustrates one example of the management information stored in the second center 10b. In FIG. 7, whether the description of the content of the software update has been completed to each vehicle (VIN) and whether the approval of the software update has been received are stored, respectively. When a format of this management information is shared between the first center 10a and the second center 10b, the first center 10a can easily understand the management information received from the second center 10b. Further, the first center 10a may refer to the management information stored in the second center 10b at any time without receiving a notification from the second center 10b.

In step S605, the process proceeds to step S607 only when an approval of the software update is obtained from the user, the manager, or the like of the vehicle (step S605, YES). When an approval of the software update is not obtained from the user, the manager, or the like of the vehicle, this processing may end by setting a time limit and without executing the software update processing.

(Step S606) As a response to the information on the software update, the first center 10a determines whether an update approval notification has been received from the vehicle (the OTA master 30). By receiving this update approval notification, the first center 10a can determine that the user, the manager, or the like of the vehicle has understood the content of the software update and then agreed on the update. The update approval notification can be transmitted to the first center 10a by, for example, pressing the approval switch provided in advance inside the vehicle. The process proceeds to step S608 only when the update approval notification is received from the vehicle (the OTA master 30) (step S606, YES). When the update approval notification cannot be received from the vehicle (the OTA master 30), this processing may end by setting a time limit and without executing the software update processing.

(Step S607) The second center 10b transmits, to the first center 10a, a notification indicating that the information on the software update has been provided to the user, the manager, or the like of the vehicle. By this notification, the first center 10a can determine that the description of the software update to the user, the manager, or the like of the vehicle has been completed and that the software update approval has been received from the user, the manager, or the like of the vehicle. When the notification is transmitted to the first center 10a, the process proceeds to step S608.

(Step S608) The first center 10a causes the processing (the download, the installation, the activation) for updating the software of the target ECU mounted on the vehicle to be executed. As such, the processing for transmitting the information on the software update ends.

FIG. 8 is a flowchart describing one example of software update control processing executed by the first center 10a, the OTA master 30, and the target ECU. FIG. 8 is an example of a software update sequence after the above-described processing for transmitting the information on the software update (FIG. 6) is executed in the download phase for obtaining a download permission in the software update processing.

The processing for transmitting the information on the software update (FIG. 6) may be executed not only in the download phase described in the present embodiment but also in the installation phase for obtaining an installation permission in the software update processing or in the activation phase for obtaining an activation permission in the software update processing.

(Step S801) The first center 10a determines whether there is a download request for the distribution package from the OTA master 30. The process proceeds to step S802 only when there is a download request (step S801, YES).

(Step S802) The OTA master 30 downloads the update data. In more detail, the OTA master 30 receives the distribution package including the update data transmitted from the first center 10a. The OTA master 30 stores the received distribution package in the storage unit 37. When the update data is downloaded, the process proceeds to step S803.

(Step S803) The OTA master 30 installs the software on the target ECU based on the update data. In more detail, based on the information included in the distribution package, the OTA master 30 transfers the update data included in the distribution package to the target ECU and gives the target ECU an instruction on the installation of the update software, which is processing for writing the update data on a data storage area. When the update software is installed, the process proceeds to step S804.

(Step S804) The OTA master 30 activates the update software installed on the target ECU. In more detail, based on the information included in the distribution package, the OTA master 30 gives an instruction on the activation of the update software to the target ECU that has written the update software on its data storage area. The target ECU restarts when a specific input operation, such as power supply OFF, is executed, and executes the update software. When the update software is activated, the software update control processing ends.

As above, according to the network system according to one embodiment of the present disclosure, when the software update for the ECU mounted on the vehicle is executed, in the case where the display device 70 mounted on the vehicle cannot sufficiently display information on the software update, the second center 10b provides the information on the software update to the user, the manager, or the like of the vehicle using a telephone or a postcard.

By this processing, even when the user, the manager, or the like of the vehicle does not separately own a device (for example, an information terminal, such as a smartphone or a personal computer, which can wirelessly communicate with the vehicle) that replaces the display device, such as a car navigation device, he or she can receive the required information on the software update using the OTA. Thus, after it is determined that the user, the manager, or the like of the vehicle has understood the content of the software update and agreed on the update, it is possible to cause the processing for updating the software of the target ECU mounted on the vehicle to be executed.

In the above-described embodiment, the first center 10a first determines whether the display device 70 mounted on the vehicle can sufficiently display the information on the software update. However, without making this determination, the information on the software update may be uniformly provided to the user, the manager, or the like of the vehicle according to a rule determined in advance. Alternatively, the information on the software update may be provided according to a contact method desired by the user, the manager, or the like of the vehicle, respectively.

As above, one embodiment of the technology of the present disclosure has been described, but the present disclosure can be regarded not only as a system including a first center and a second center, or a first center, but also as a method executed by the first center including one or more processors and one or more memories, a program, a computer-readable non-transitory storage medium storing the program, an OTA master that can communicate with the first center, a vehicle including the OTA master, or the like.

The technology of the present disclosure can be used in a network system used for updating software of an ECU mounted on a vehicle.

What is claimed is:

1. A system configured to control a software update for an electronic control unit mounted on a vehicle, the system comprising:
a first center including one or more first processors configured to execute processing for the software update on the vehicle;
the vehicle configured to execute the software update for the electronic control unit based on the processing by the first center; and
a second center including one or more second processors configured to
provide information on the software update to a user of the vehicle, and
transmit, to the first center, a notification indicating that the information on the software update is provided to the user of the vehicle,
the one or more first processors of the first center being configured to, after receiving the notification from the second center, execute the processing on the vehicle based on the notification.

2. The system according to claim 1, wherein the notification further indicates that the user of the vehicle approves the processing for the software update.

3. The system according to claim 2, wherein:
the vehicle is provided with a switch that is operated when the user of the vehicle approves the processing for the software update; and
the vehicle is configured to transmit a notification on an approval of the processing for the software update to the second center when the switch is operated.

4. The system according to claim 2, wherein the processing for the software update includes processing for downloading update data for the software update on the vehicle, installing update software based on the update data, and activating the update software.

5. A method executed by a first center, the first center including one or more processors and a memory, the first center composing a system controlling a software update for an electronic control unit mounted on a vehicle, the first center being configured to execute processing for the software update on the vehicle, and the method characterized by comprising:
receiving a notification indicating that information on the software update is provided to a user of the vehicle from a second center configured to provide the information on the software update to the user of the vehicle; and
executing, after receiving the notification from the second center, the processing on the vehicle based on the notification.

6. A non-transitory storage medium storing instructions that are executable by a computer of a first center and that cause the computer to execute functions, the first center including one or more processors and a memory, the first center composing a system controlling a software update for an electronic control unit mounted on a vehicle, the first center being configured to execute processing for the software update on the vehicle, and the functions characterized by comprising:
receiving a notification indicating that information on the software update is provided to a user of the vehicle from a second center configured to provide the information on the software update to the user of the vehicle; and
executing, after receiving the notification from the second center, the processing on the vehicle based on the notification.
